(19) United States
(12) Patent Application Publication
(10) Pub. No.: US 2006/0111814 A1
(43) Pub. Date: May 25, 2006

(54) Mobile robot

(76) Inventors: Shuji Hachitani, Shijyounawate-shi (JP); Yuji Adachi, Hirakata-shi (JP)

Correspondence Address: WENDEROTH, LIND & PONACK L.L.P., 2033 K. STREET, NW, SUITE 800, WASHINGTON, DC, 20006, US

(21) Appl. No.: 11/280,305

(22) Filed: Nov. 17, 2005

(30) Foreign Application Priority Data
Nov. 19, 2004 (JP) 2004-335637
Nov. 19, 2004 (JP) 2004-335831

(51) Int. Cl. G06F 19/00

(52) U.S. Cl. 700/258; 700/245; 318/568.12

(57) ABSTRACT

A mobile robot, which enables sure detection of external environments including obstacles around the mobile robot, without being affected by a posture change of the mobile robot, and includes: an obstacle detection sensor, placed on a stage that can sway, which detects an obstacle around the mobile robot; and an actuator which controls a posture of the obstacle detection sensor in a pitching direction by oscillating the stage.

### BACKGROUND OF THE INVENTION

(1) Field of the Invention

The present invention relates to a mobile robot which moves while detecting an environment surrounding the mobile robot, and in particular, to a mobile robot which can autonomously move while detecting presence/absence of surrounding obstacles. The present invention also relates to an autonomous mobile robot, which is loaded with objects to be carried and moves, following or leading a predetermined person, in a space crowded with the general public, e.g., a shopping center, a hotel, an airport and a public institution.

(2) Description of the Related Art

In the conventional mobile robot, an external environment detection unit is set in a fixed position so that the mobile robot corrects an output signal obtained from the external environment detection unit and cancels a change in a posture of the mobile robot. This is because the state of detection performed by the external environment detection unit changes according to the posture change of the mobile robot (see reference to Japanese Laid-Open Application No. 2004-74814).

FIG. 1 is a block diagram showing a conventional device described in the Japanese Laid-Open Application No. 2004-74814. FIG. 2 is a flowchart related to an obstacle detection performed by the device shown in FIG. 1. The device includes: an operation unit 50; an operation sensor 51; a posture detection sensor 52, e.g., a gyro or an inclinometer which detects a posture of the mobile robot; an obstacle detection sensor 53 which is a kind of the external environment detection unit; a control panel 54 which has a display unit 55 and an obstacle annunciation output unit 56; drive wheels 57; a drive motor 58 which drives for rotations of the drive wheels 57; drive circuits 59 which controls a drive of the drive monitor 58; an auxiliary wheel 60; an auxiliary wheel drive unit 61 for letting the auxiliary wheel appear; a drive circuit 62 which controls a drive of the auxiliary wheel drive unit 61; a speed detection circuit 65; and a control circuit C.

According to the conventional art, a mobile robot body is equipped with two drive wheels 57 and one auxiliary wheel 60, and is conceived as a device which moves by driving the drive wheels 57. A correction is made to cancel, using the output of the posture detection sensor 52 which detects a state of the mobile robot's posture, a posture change of the mobile robot based on the output signal of the obstacle detection sensor 53 that serves as the external environment detection unit. A person riding the mobile robot is notified of the presence of obstacle based on the signal after such correction is made.

Note that, in the flowchart shown in FIG. 2, an operation of retracting the auxiliary wheel 60 may be inserted into a part A, while an operation of deploying the auxiliary wheel 60 may be inserted into a part B.

A carrier robot system which enables autonomous operation within a medical institution (see reference to pp. 7-11 and FIG. 1 in Japanese Laid-Open Application No. 09-267276) can be raised as an example of the conventional mobile robot which moves with the objects to be carried on board.

FIG. 3 is a diagonal view of a meal carrier robot system being an embodiment of the conventional carrier robot system described in the Japanese Laid-Open Application No. 09-267276.

In FIG. 3, a meal-carrier robot 101 includes: a storing unit 115 which can store an object to be carried; visional sensors 116 and 117; an environment measurement recognition apparatus for running 118 which operates based on the visional sensors 116 and 117; a robot operation path generation unit which operates based on the result of the measurement and recognition obtained by the environment measurement recognition apparatus; a moving mechanism 108 which can autonomously move based on a running instruction given by a run control apparatus 120 that uses a path generated by the robot operation path generation unit and an obstacle detection sensor 119, based on the result of the measurement and recognition obtained by the environment measurement and recognition apparatus for running 118; and interface units 121 and 122 which performs communication with an operator or the like.

However, with the conventional structure, in the case where the posture change of the mobile robot is large, an obstacle may be located outside an area to be detected by the obstacle detection sensor so that the obstacle detection sensor is not capable of detecting the obstacle, or that the obstacle detection sensor erroneously detects a surface on which the mobile robot moves as an obstacle. In such case, a problem is that an obstacle cannot be detected even though data of the obstacle detection sensor is corrected according to posture change.

The present invention is conceived to solve the above problem, and a first object of the present invention is to provide a mobile robot which can detect, without fail, an environment surrounding the mobile robot, using an external environment detection unit as represented by an obstacle detection sensor.

The conventional structure has a complex structure and a large size since a moving mechanism consists of two drive wheels, and plural driven wheels, each of which freely rotates. This requires a huge space for the wheels to circle around and makes it difficult to promptly move.

The present invention is to solve the existing problem, and a second object of the present invention is to provide a mobile robot which requires a small space to turn, promptly increases or decreases its speed, moves speedily and astutely on the surface on which the mobile robot moves, and can easily load and carry an object to be carried.

### SUMMARY OF THE INVENTION

In order to achieve the above problem, the mobile robot according to the present invention includes: a mobile robot comprising: a mobile robot body; an external environment detection unit which is placed on the mobile robot so as to be movable, and detects an external environment; and a control unit operable to control a posture of the external environment detection unit.

According to the above structure, it is possible to detect, without fail, an external environment including obstacles around the mobile robot.

It is desirable that the mobile robot body also includes: two drive wheels which belong to a same rotation axis and are separately rotatable; and a rotation control unit which controls rotations of said drive wheels, and controls a position of the mobile robot body in an anteroposterior direction and a posture of the mobile robot body in a pitching direction.

With the above structure, it is possible to control the oscillation due to the surface on which the mobile robot body moves, and to astutely move the surface bi-dimensionally.

The mobile robot may further include a gantry frame placed above the mobile robot body so that the gantry frame protrudes upward, wherein the external environment detection unit is placed on the top of the gantry frame.

With the above structure, the mobile robot can freely move on the surface without dropping a loaded object, and to properly recognizes the external environment so as to avoid as much as possible contacts with obstacles.

### FURTHER INFORMATION ABOUT TECHNICAL BACKGROUND TO THIS APPLICATION

The disclosure of Japanese Patent Applications No. 2004-335637 and No. 2004-335831 which are filed on Nov. 19, 2004, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention.

In the Drawings:

FIG. 1 is a block diagram showing an example of a conventional mobile robot;

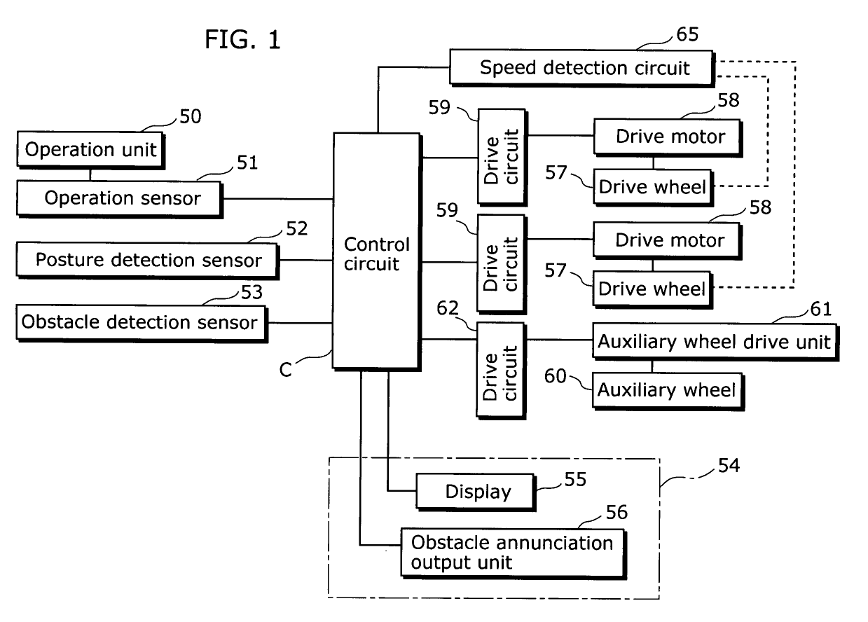

FIG. 2 is a flowchart related to obstacle detection as an example of the operation performed by the conventional mobile robot;

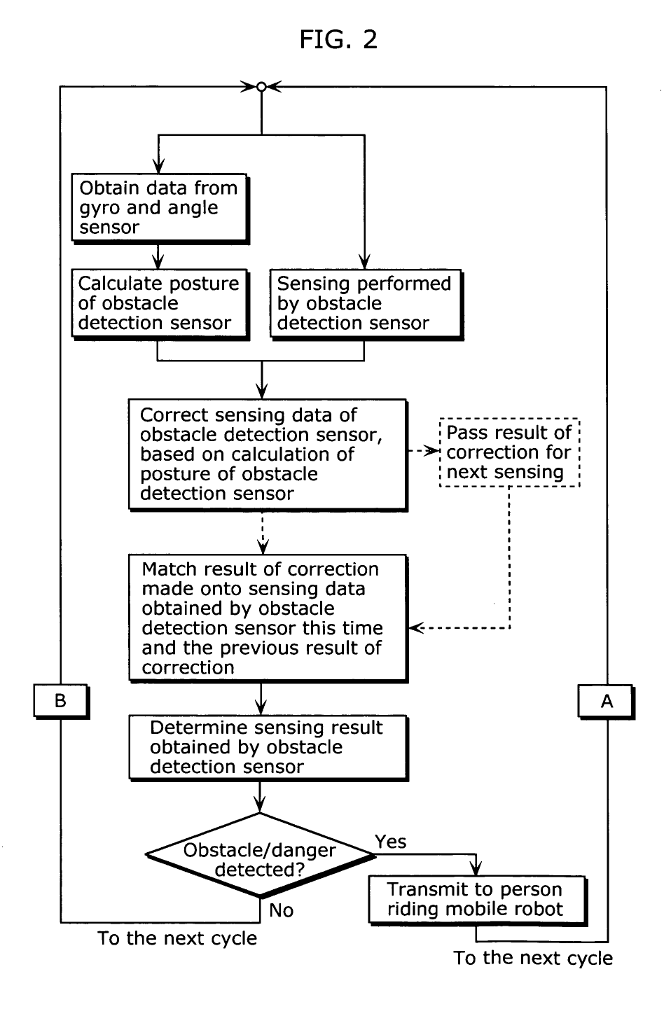

FIG. 3 is a diagonal view showing the conventional carrier robot system;

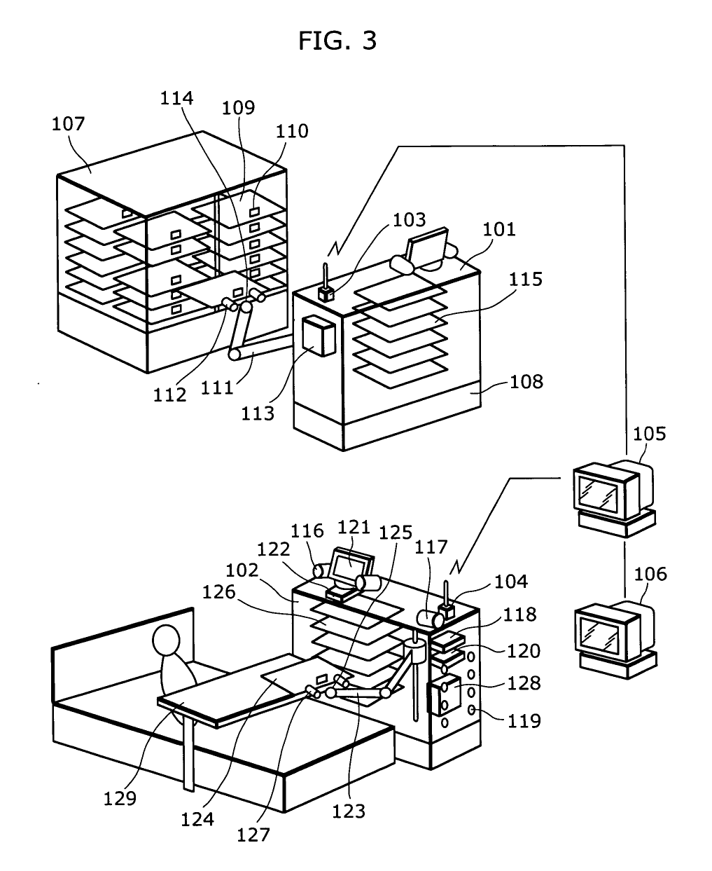

FIG. 4 is a diagonal view of a mobile robot according to a first embodiment of the present invention;

FIG. 5 is a block diagram showing a functional structure of a mobile robot 100;

FIG. 6 is a flowchart showing a flow of the processing for maintaining an external environment detection sensor 6 in a predetermined posture;

FIG. 7 is a diagonal view of the mobile robot 100 according to a second embodiment of the present invention;

FIG. 8 is a diagonal view of the mobile robot 100 according to a third embodiment of the present invention;

FIG. 9 is a diagonal view of the mobile robot according to a fourth embodiment of the present invention;

FIG. 10 is a diagonal view of the mobile robot 100 according to a fifth embodiment of the present invention;

FIG. 11 is a diagonal view of the mobile robot 100 according to a sixth embodiment of the present invention; and

FIG. 12 is a diagonal view of the mobile robot according to a seventh embodiment of the present invention.

### DESCRIPTION OF THE PREFERRED EMBODIMENT(S)

The following describes the embodiments of the present invention, with reference to the diagrams.

### FIRST EMBODIMENT

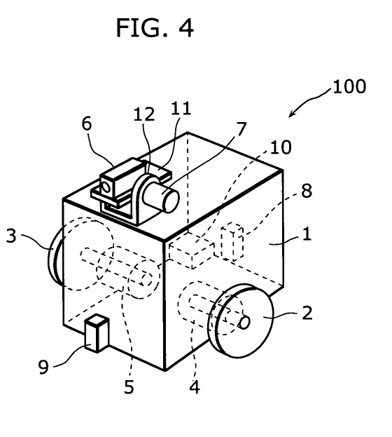

FIG. 4 is a diagonal view of the mobile robot according to the first embodiment of the present invention.

As shown in the diagram, the mobile robot 100 includes: a mobile robot body 1; drive wheels 2 and 3 which are coaxially placed as opposed in a direction orthogonal to a moving direction, on both sides of the mobile robot body 1; an obstacle detection sensor 6 that is a kind of the external environment detection unit; an actuator 7 such as a motor which controls its posture by driving the obstacle detection sensor 6 in a pitching direction; a posture detection sensor 8, such as a gyro sensor, which is fixedly set on the mobile robot body 1 and detects a posture of the mobile robot body 1; an angle detection sensor 9 which is fixedly set on the mobile robot body 1 and detects a relative angle between the mobile robot body 1 and a surface on which the mobile robot moves; and a control box 10.

An obstacle to be detected by the obstacle detection sensor 6 is something that gets in the mobile robot's way, for example, a chair, a plant and a trash bin.

Drives for the drive wheels 2 and 3 are controlled by motors 4 and 5 which are separately placed in the mobile robot body 1.

The obstacle detection sensor 6 is mounted on a stage 11 in such a manner that its position is changeable.

The stage 11 is held by a support 12 so as to be movable in a pitching direction. The support 12 is fixedly set on the top surface of the mobile robot body 1.

The actuator 7 is coupled to the support 12, and by the fact that the actuator 7 drives the stage 11, the obstacle detection sensor 6 is driven in a pitching direction so that the posture of the obstacle detection sensor 6 is controlled.

Such structure as described above enables separate control over the posture of the obstacle detection sensor 6 in a pitching direction and the posture of the mobile robot body 1 in a pitching direction.

The control box 10 includes, in the interior, a rotation control unit (not shown in the diagram) which controls the motors 4 and 5, using output values or operation input values respectively inputted from the respective sensors, and a sensor posture control unit (not shown in the diagram) as a control unit which controls the actuator 7.

It should be noted that, according to the above structure, the obstacle detection sensor 6 is equipped on the stage 11 that is mobile in a pitching direction, however, this is to allow the position of the obstacle detection sensor 6 to be changeable. The same effect can be obtained in the case where the obstacle detection sensor 6 is equipped directly to the mobile robot body 1 without the stage 11 so that the sensor 6 is mobile in a pitching direction and the actuator 7 directly controls a drive of the obstacle detection sensor 6.

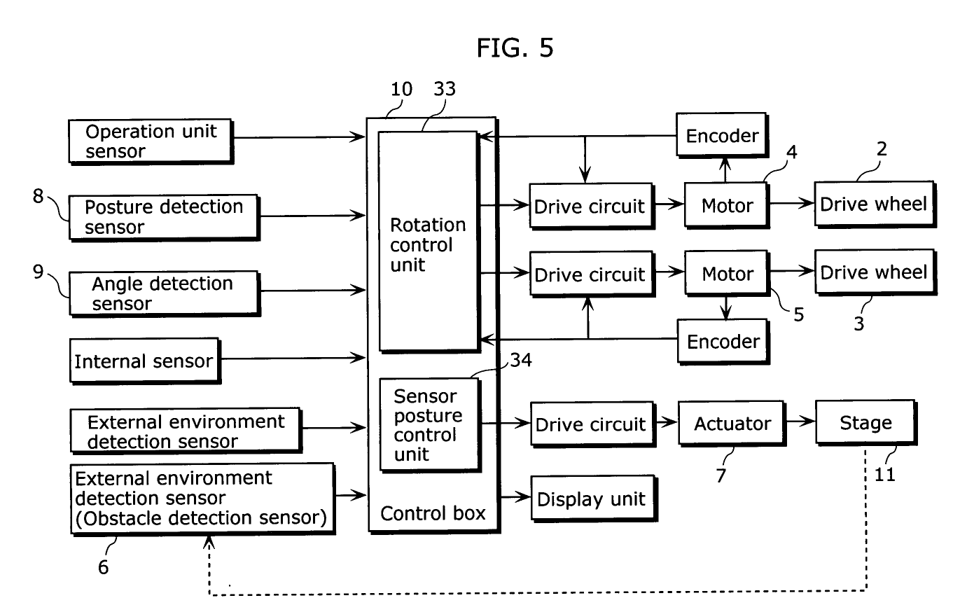

FIG. 5 is a block diagram showing a functional structure of the mobile robot 100.

As shown in the diagram, the mobile robot 100 includes inside the control box 10: a rotation control unit 33 which controls rotation of the drive wheels 2 and 3; and a sensor posture control unit 34 as a control unit which controls a posture of the external environment detection sensor 6 on the stage 11.

The rotation control unit 33 analyzes signals from an operation unit sensor and an internal sensor, as well as the posture detection sensor 8, the angle detection sensor 9 and the obstacle detection sensor 6, and controls the motors 4 and 5 via a drive circuit so that the mobile robot body 1 does not tumble. The rotation control unit 33 also controls, if necessary, the motors 4 and 5 so that the mobile robot body 1 moves, while optimally controlling the posture of the mobile robot body 1.

Note that the state of rotation of the motors 4 and 5 is transformed into signals by an encoder, and the signals from the encoder are used for feedback control.

The sensor posture control unit 34 analyzes, in particular, a signal from the posture detection sensor 8, and controls the actuator 7 via a drive circuit so that the posture of the obstacle detection sensor 6 is always maintained horizontal. The sensor posture control unit 34 also analyzes, in particular, a signal from the angle detection sensor 9, and controls the actuator 7 via a drive circuit so that the posture of the obstacle detection sensor 6 is always paralleled to the surface on which the mobile robot body 1 moves. Whether the posture should be always horizontal or parallel to the surface shall be selected arbitrarily or based on a signal from a sensor such as the obstacle detection sensor 6.

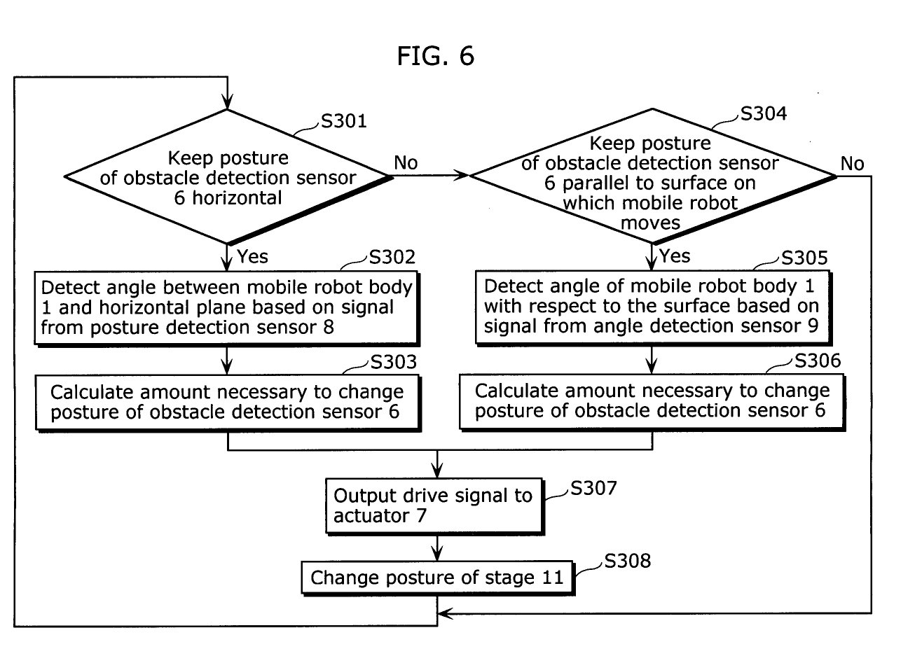

FIG. 6 is a flowchart showing a flow of the processing of maintaining the obstacle detection sensor 6 in a predetermined posture.

The sensor posture control unit 34 firstly judges whether or not to keep the posture of the obstacle detection sensor 6 horizontal (S301). The judgment may be made, for example, based on a value arbitrarily inputted or a state of the surface previously passed by the mobile robot body 1.

In the case of judging that the posture should be maintained horizontal (Yes in S301), the sensor posture control unit 34 detects an angle made between the mobile robot body 1 and a horizontal plane, based on the signal of the posture detection sensor 8 (S302).

The sensor posture control unit 34 then calculates an amount necessary to change the present posture of the obstacle detection sensor 6 for maintaining the posture of the obstacle detection sensor 6 horizontal (S303).

In the case of not judging that the posture should be horizontal (No in S301), the sensor posture control unit 34 judges whether or not to keep the posture of the obstacle detection sensor 6 parallel to the surface on which the mobile robot body 1 moves (S304).

In the case of judging that the posture should be made parallel to the surface (Yes in S304), the sensor posture control unit 34 detects an angle made between the mobile robot body 1 and the surface, based on a signal of the angle detection sensor 9 (S305).

The sensor posture control unit 34 then calculates an amount necessary to change the present posture of the obstacle detection sensor 6 for maintaining the posture of the obstacle detection sensor 6 to be parallel to the ground (S306).

The sensor posture control unit 34 then outputs a drive signal to the actuator 7 based on the amount necessary to change the posture calculated in S303 or S306 (S307), and changes the posture of the stage 11 so that the obstacle detection sensor 6 is made horizontal or parallel to the surface (S308).

The steps described above are constantly performed during the operation of the mobile robot 100.

Thus, even in the case where the mobile robot body 1 moves while oscillating in a pitching direction on the surface, the posture of the obstacle detection sensor 6 is controlled independently from the mobile robot body 1 so that it is possible to maintain the posture to be always horizontal or parallel to the surface. As a result, it is possible to detect without fail and without delay the information relating to obstacle that blocks a path through which the mobile robot 100 passes.

It should be noted that the case of maintaining the posture of the obstacle detection sensor 6 to be horizontal or parallel to the surface is described above, however, it is possible to control the actuator 7 for maintaining the posture of the obstacle detection sensor 6 at a predetermined angle from a horizontal plane or a surface, so that a detecting part of the obstacle detection sensor 6 faces toward an arbitrary direction intended for detection.

In the first embodiment, it is assumed that the obstacle detection sensor 6 can move only in a pitching direction, however, it may move in a rolling and yawing posture. It is arbitrarily possible for the obstacle detection sensor 6 to move in vertical and horizontal directions.

FIG. 4 shows an example of applying the obstacle detection sensor as an external environment detection unit, however, sensors such as a specified or unspecified human detection sensor, a moving target position detection sensor of the mobile robot 100, a landmark detection sensor for detecting a relative position or an absolute position of the mobile robot 100 may be used as an external environment detection unit.

The movement control of the mobile robot 100 is described with the example that the rotation control unit 33 autonomously moves for determining, with the use of an output value of the various sensors, a moving operation and a moving path of the mobile robot 100 is described in the first embodiment. A person may perform remote control on the mobile robot 100 or operate the mobile robot 100 on board.

### SECOND EMBODIMENT

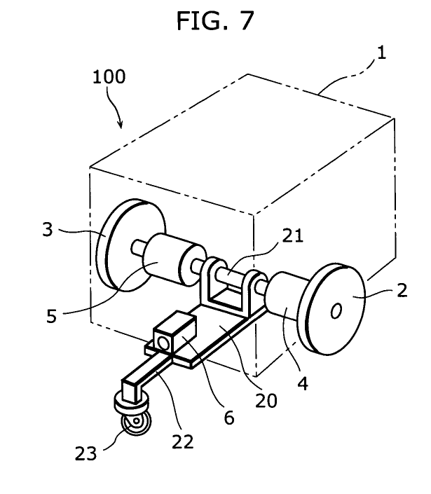

FIG. 7 is a diagonal view of the mobile robot 100 according to the second embodiment of the present invention.

In the diagram, the same referential marks are used for the same components as those shown in FIG. 4, and the description is not repeated here.

In the diagram, the mobile robot 100 includes a stage 20, a supporting axis 21 that is coaxially set as a rotation axis of the drive wheels 2 and 3.

One end of the stage 20 is coupled to the supporting axis 21 so that the stage 20 is rotatable, while the other end of the stage 20 can sway in a pitching direction with the supporting axis 21 in the center. On the stage 20, the obstacle detection sensor 6 is fixedly set.

A sensing bar 22 is joined to the other end of the stage 20 so as to protrude downwardly as a linking unit.

The sensing bar 22 consists of a rigid body, and one end of the sensing bar 22 is fixed to the stage 20 so that the sensing bar 22 can move together with the stage 20. The other end of the sensing bar 22 is coupled to a caster 23, and the sensing bar 22 allows, via the caster 23, the posture of the stage 20 to move in accordance with the change in the angle of the surface on which the mobile robot body 1 moves.

The tare weight of the stage 20 and the sensing bar 22 is slightly pressed against the surface so that the caster 23 does not come off the surface, and a distance between the stage 20 and the surface is maintained to be constant. Note that in the case where the tare weight is not heavy enough, the other end of the stage 20 may be adjusted to further press the surface, using an elastic body such as a spring.

With the structure as described above, the stage 20 is laid as a cross-link between the supporting axis 21 which constantly moves with a fixed distance from the surface and the sensing bar 22 equipped with the caster 23, while one end of the stage 20 can freely oscillate with respect to the supporting axis 21, and the sensing bar 22 maintains the distance between the other end of the stage 20 and the moving surface to be constant. Thus, it is possible to keep a constant angle with respect to the surface. For example, by setting a total length of the sensing bar 22 in a vertical direction and the caster 23 in such a way that the stage 20 becomes parallel to the surface, it is possible to constantly maintain the posture of the stage 20 to be parallel to the surface.

As a result, even in the case where the mobile robot body 1 oscillates in a pitching direction with respect to the surface, the obstacle detection sensor 6 fixed on the stage 20 can maintain the posture to be almost stable with respect to the surface despite the oscillation. That is to say, it is possible to detect, without fail and without delay, the information relating to an obstacle that gets in the way of the moving body only, with mechanic control without requiring electric control.

It should be noted that in the second embodiment, a cushioning material such that is made up of a spring or a damper, which absorbs the oscillation of the stage 20 caused by small bumps on the surface, may be set between the sensing bar 22 and the caster 23 coupled to the other end of the sensing bar 22.

FIG. 7 shows the structure in which the sensing bar 22 is placed at the front of the mobile robot 100.

### THIRD EMBODIMENT

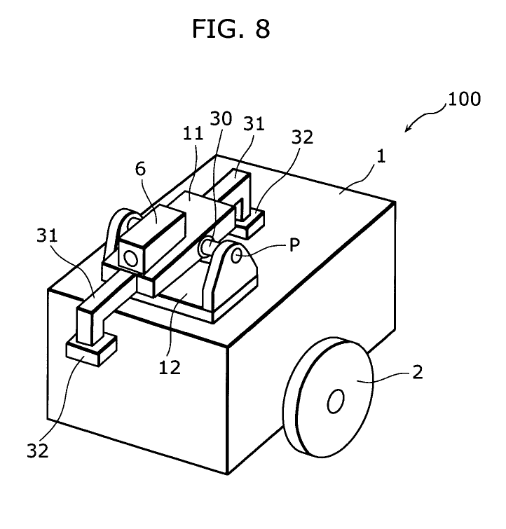

FIG. 8 is a diagonal view of the mobile robot 100 according to the third embodiment of the present invention. In the diagram, the same referential marks are used for the same components as those shown in FIG. 4 and FIG. 7, and the description is not repeated here.

As shown in the diagram, the mobile robot 100 includes a supporting axis 30 placed on the stage 11, and a support 12 having a bearing part which supports the both ends of the supporting axis 30.

The stage 11, fixed to the supporting axis 30, can sway in a pitching direction with the supporting axis 30 serving as an axis. Note that the supporting axis 30 may be fixed to the support 12 so that the stage 11 is rotatable with respect to the supporting axis 30.

The stage 11 has bars 31, each extending in a direction orthogonal to the supporting axis 30 from each end of the stage 11. A weight 32 droops from the end of the respective bars 31.

The weights 32 are set in front and back of the stage 11 in order to keep the posture of the stage 11 to be stable, and are placed so that a line connecting the centers of gravity of the respective weights 32 passes below a supporting point P which keeps the stage 11 rotatable, in the case where the mobile robot 100 stops in a horizontal posture.

With such structure as described above, even in the case where the mobile robot body 1 sways in a pitching direction with respect to the surface, it is possible for the stage 11 and the obstacle detection sensor 6 to keep their postures to be almost horizontal by the fact that a restoring force works in a horizontal direction owing to the weight added to the weight 32 placed in front and back of the stage 11. Such simple structure makes it possible to detect the information relating to the obstacle that gets in the way of the mobile robot 100.

It should be noted that, in the third embodiment, the stage 11 can move only in a pitching direction, however, the stage 11 may also move in a rolling direction. In this case, it is desirable to keep the stage mobile by a gimbal mechanism, a spherical bearing mechanism, and a float mechanism based on buoyant force or magnetic force. The weights for keeping the posture stable are placed in two places in front and back of the stage 11, however, only one weight may be placed directly under the supporting point P that keeps the stage 11 rotatable.

### FOURTH EMBODIMENT

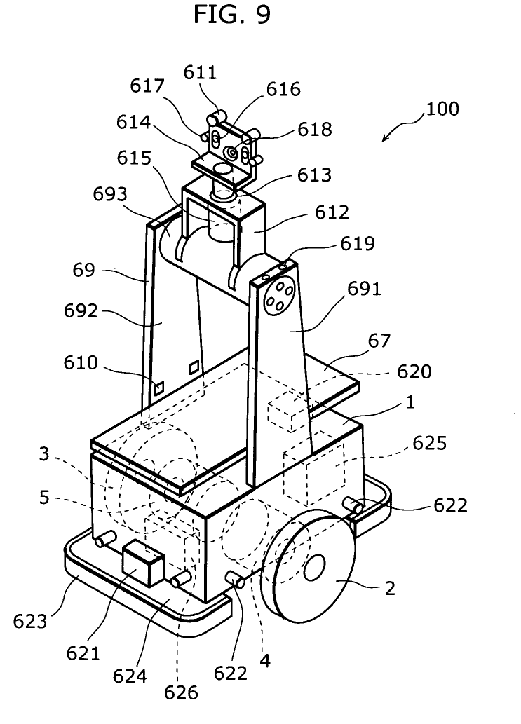

FIG. 9 is a diagonal view of the mobile robot 100 according to the fourth embodiment of the present invention.

As shown in the diagram, the mobile robot 100 includes: a mobile robot body 1 to be mentioned later; a gantry frame 69 set above the mobile robot body 1; a loading unit 67, placed between the gantry frame 69 and the mobile robot body 1, which loads objects to be transported; and an external environment detection unit 621, placed above the gantry frame 69 for detecting external environment.

The mobile robot 100 includes, as described below, various components for moving on the surface.

The mobile robot 100 has the drive wheels 2 and 3 which are set coaxially on both sides of the mobile robot body 1.

The drives for the drive wheels 2 and 3 are controlled by the motors 4 and 5 which are independently set in the mobile robot body 1.

Such structure without driven wheels enables the mobile robot 100 to rotate in a small turning radius and to promptly move with excellent adjustable speed, on the surface.

The loading unit 67 is a so-called carrier fixedly placed above the mobile robot body 1. The loading unit 67 is formed between the gantry frame 69 and the mobile robot body 1, and can load an object to be carried. An open space above the loading unit 67 allows easy loading of the object such as a baggage.

The gantry frame 69 is formed by the following: a pair of side-pillars 691 and 692 whose bottom parts are respectively fixed to a center of the side edges; and a top linking member 693 which bridges between the top ends of the side-pillars 691 and 692.

The gantry frame 69 has photoelectric sensors 610 in the lower part of at least one of the side-pillars 691 and 692, just above the top surface of the loading unit 67. The photoelectric sensor 610 is a sensor that detects presence of an object loaded on the loading unit 67.

In the present embodiment, the mobile robot 100 has an ultrasonic sensor 611 as an external environment detection unit. The ultrasonic sensor 611 is a sensor which detects a direction of and a distance to a location of a specific person by detecting ultrasound waves emitted from an ultrasound emitter held by the specific person.

The ultrasonic sensor 611 is fixed to a bracket 614 which is rotatably held via a bearing 613, and is fixed to a support member 612 placed on a top linking member 693 being the top of the gantry frame 69, so that the support member 612 can sway. As is the case of the first embodiment, the support member 612 can also control the swaying, by an actuator (not shown in the diagram) equipped in the top linking member 693, so that the posture of the ultrasonic sensor 611 is constantly maintained to be horizontal. Additionally, the bracket 614 is structured to be rotatable in horizontal direction by a motor 615, therefore, the ultrasonic sensor 611 fixed to the bracket 614 is also rotatable in the horizontal direction.

With such structure as described above, it is possible to place the gantry frame 69 with high rigidity above the mobile robot body 1 while keeping the condition where a gravitational position of the entire mobile robot 100 is in the upper part of an rotation axis common to the two drive wheels 2 and 3 placed on both sides of the mobile robot body 1, when the posture of the mobile robot 100 is in the center of an oscillation angle in a pitching direction. It is also possible to keep the ultrasonic sensor 611 stable on the top of the mobile robot 100 which has fewer dead angles. Also, the form of the gantry frame 69 allows a big space for loading an object to be carried above the mobile robot body 1.

In addition, since it is also possible to detect the ultrasound waves emitted by the ultrasound emitter, always within the same field of view, without loosing sight of the ultrasound emitter. This is because the posture of the ultrasonic sensor 611 is constantly maintained, by control, to be horizontal even in the case where the mobile robot 100 sways while moving.

The mobile robot 100 also includes an LED 616 which displays a state of the mobile robot 100; a speech recognition unit 617 which recognizes a speech of the operator, or the like; a speech generation unit 618 for transmitting information or the like to the operator via audio. The LED 616, the speech recognition unit 617 and the speech generation unit 618 are fixed to the bracket 14, as is the case of the ultrasonic sensor 11, so that they can rotate and sway in a horizontal direction.

The mobile robot 100 also includes a photoelectric sensor 619 either on the top linking member 693 of the gantry frame 69 or on the upper part of at least one of the side-pillars 691 and 692. The photoelectric sensor 619 can be operated without being contacted.

Each of the LED 616, the speech recognition unit 617, the speech generation unit 618 and the photoelectric sensor 619 functions as an interface for communication with the operator or the like, and are placed at the height that enables the operator to smoothly communicate, namely, in the upper part of the gantry frame 69.

The mobile robot 100 is further equipped with the following: a gyro sensor 620 as an oscillation angle detection sensor which detects an oscillation angle of the mobile robot 100; an infrared scanning sensor 621 which is placed in the center of the front surface of the mobile robot body 1 and detects an obstacle; ultrasonic sensors 622 near the lower corners of the both of the lateral sides of the mobile robot 1, each sensor detecting an obstacle on the surface; a contact detection sensor 623 which is placed in bumpers 624 located in the lower front and back of the mobile robot body 1; a control box 625 internally equipped with a rotation control unit (not shown in the diagram) which calculates for the operation and the moving path of the mobile robot body 1 based on input signals from the various sensors mentioned above, the speech recognition unit 617 or the photoelectric sensor 619, and which emits an instruction signal to a driving unit such as the motor drive circuit 626; a communication control unit (not shown in the diagram) which outputs an instruction signal to the interface unit such as the LED 616 and the speech generation unit 618; and a posture control unit (not shown in the diagram) which controls an actuator for keeping the posture of the ultrasonic sensor 611 to be constant.

Here, the infrared scanning sensor 621 and the contact detection sensor 623 are constructed as described in the second embodiment, and it is possible to keep the posture with respect to the surface to be almost constant.

With the structure such as the following: the mobile robot body 1 which moves in such a manner that the body 1 may sway in a pitching direction with respect to the surface due to a frictional force between the two drive wheels 2 and 3, and the surface; the gyro sensor 620 which detects an oscillation angle of the mobile robot 100, various control units and the motor drive circuit 626; the loading unit 67 for loading the object to be carried; and the ultrasonic sensor 611 placed above the loading unit 67, it is possible to control the oscillation in a pitching direction with respect to the surface on which the mobile robot 100 moves as well as to load an object to be carried on the mobile robot 100 and bi-dimensionally and autonomously move on the surface. Thus, it is possible to provide the mobile robot 100 which has an ability to turn in a small radius and can move autonomously with high speed in a space crowded with the general public, as well as to adjust the speed and easily load and carry the object, and does not easily lose an object to be detected.

In the present embodiment, the two drive wheels 2 and 3 are placed coaxially on the both sides of the mobile robot body 1. Alternatively, a globoid driving rotator may be set in the center of the mobile robot body 1.

The loading unit 67 for loading a load is structured in tabular form, but may be structured in form of a seat so as to carry a person.

The present embodiment describes that a pair of side-pillars 691 and 692 are each fixed to a position located almost at the center of each side edge of the mobile robot body 1. The fixed position, however, is not limited to this position. For example, the side-pillars 691 and 692 may be fixed in the position located almost at the center of the respective front and rear edges of the mobile robot body 1 so that the gantry frame 69 is rotated by 90 degrees from the position shown in FIG. 9.

It should be noted that a pair of side-pillars 691 and 692 of the gantry frame 69 prevents a loaded object from falling. Since the top linking member 693 is supported by the pair of side-pillars 691 and 692, it is possible to safely set the ultrasonic sensor 611 and the like onto the top linking member 693. Based on the above points, it is desirable that the gantry frame 69 has a gate-like form.

A sensor for detecting presence of a load is not limited to the photoelectric sensor 610, and a detector such as a weight sensor and a micro switch may be used for the detection.

An apparatus for determining a moving direction of the mobile robot 100 is not restricted to the ultrasonic sensor 611, and something, such as a steel camera and an omnidirectional camera, which visually detects an external environment and gives information, or a sensor like a photoelectric sensor, or a combination of the two may be used instead.

The bracket 614 is structured to be rotatable in a horizontal direction by the motor 615, however, the bracket 614 may be made rotatable in a vertical direction or another direction.

An interface for the communication between the mobile robot 100 and the user is not limited to the contactless photoelectric sensor 619, and a contact type switch may be used instead.

The gyro sensor 20 is used as a sensor to detect an oscillation angle of the mobile robot 100, however, a sensor such as an acceleration sensor, an encoder and a potentiometer, or a combination of them may be used instead.

The mobile robot 100 is structured to be autonomously mobile based on detection signals of the various sensors, however, the mobile robot 100 may be operated by remote control or by a person riding the mobile robot 100.

### FIFTH EMBODIMENT

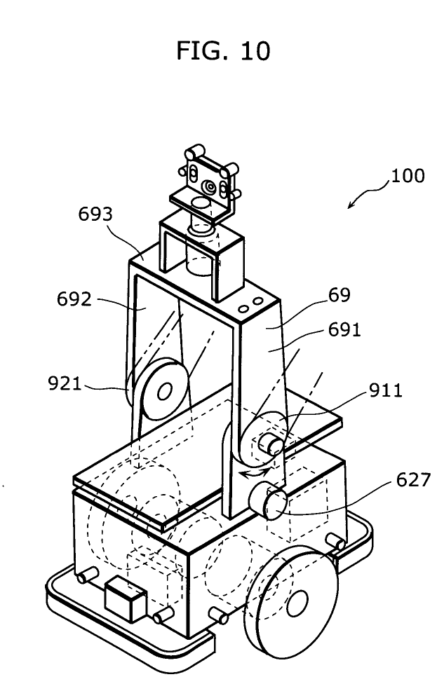

FIG. 10 is a diagonal view of the mobile robot 100 according to the fifth embodiment of the present embodiment. In the diagram, the same referential marks are used for the same components as those shown in FIG. 9, and the description is not repeated here.

As shown in the diagram, rotating members 911 and 921 are placed in the lower part of the side-pillars 691 and 692 of the gantry frame 69. The gantry frame 69 is placed to be rotatable around a rotation support axis 694 that is fixed to the mobile robot body 1 via the rotating members 911 and 921.

A driving force is given to the rotation around the rotation support axis 694 by the actuator 627. In the actuator 627, a brake for controlling the rotation of the gantry frame 69 to keep the gantry frame 69 in a predetermined position is incorporated.

With the above structure, an open space is made above the loading unit 67 by rotating the gantry frame 69 around the rotation support axis 694 at the time of taking in and out a load, so that the loading can be easily carried out.

### SIXTH EMBODIMENT

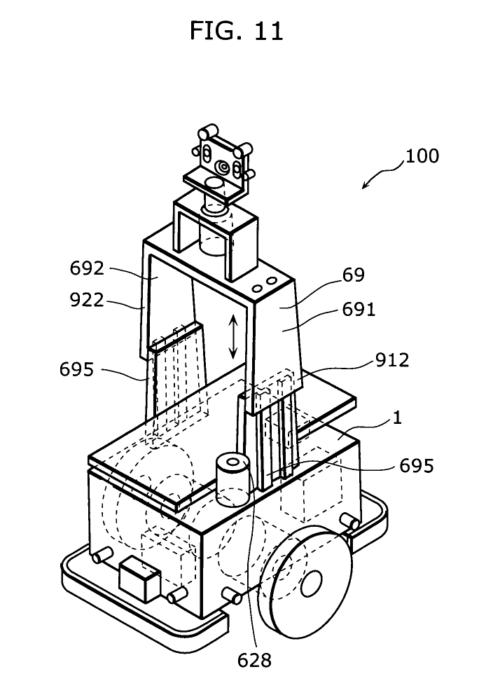

FIG. 11 is a diagonal view of the mobile robot 100 according to the sixth embodiment of the present invention. The same referential marks are used for the same components as those shown in FIGS. 9 and 10, and the description is not repeated here.

As shown in FIG. 11, linear motion guiding members 912 and 922 are placed in the lower part of the side-pillars 691 and 692 of the gantry frame 69. The gantry frame 69 is set onto the mobile robot body 1 so that the gantry frame 69 is linearly mobile in a vertical direction along direct-acting rails 695 which are fixed to the mobile robot body 1.

A driving force which moves in a vertical direction along the direct-acting rails 695 is given to the gantry frame 69 by an actuator 628. In the actuator 628, a brake for controlling the rotation of the gantry frame 69 to keep the gantry frame 69 in a predetermined position is incorporated.

With the above structure, an open space in the upper part of the loading unit 67 is enlarged by extending the gantry frame 69 along the direct-acting rails 695 at the time of taking in and out a load, so that the loading can be easily carried out.

The extension of the gantry frame 69 along the direct-acting rails 695 also allows an interface unit, which is placed on the gantry frame 69 for the communication with the operator, to move in a horizontal direction, so that the operator can change the height of the gantry frame 69 according to the height of operator's eyes.

### SEVENTH EMBODIMENT

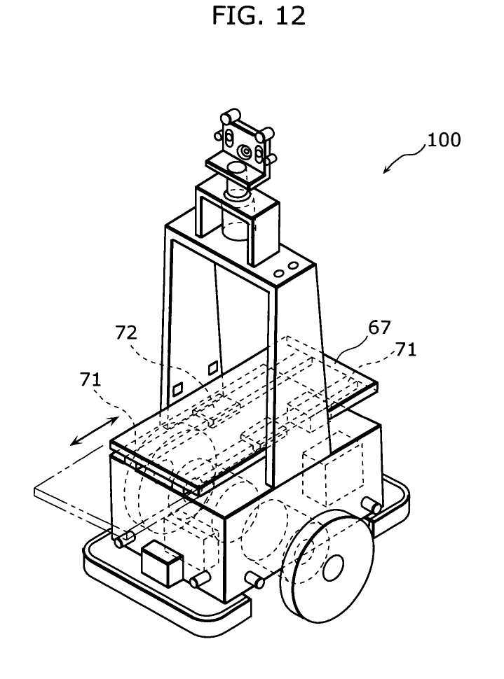

FIG. 12 is a diagonal view of the mobile robot 100 according to the seventh embodiment of the present invention. The same referential marks are used for the same components as those shown in FIGS. 9, 10 and 11, and the description is not repeated here.

As shown in the diagram, a direct-acting guide-rail 71 is fixedly set above the mobile robot body 1 and a holding member 72 is fixed to the loading unit 67 and performs direct-acting movement along the guide-rail 71.

With the above structure, an open space above the loading unit 67 is enlarged by moving the loading unit 67 along the guide-rail 71 at the time of taking in and out a load, so that the loading can be easily carried out.

The actuator may move the loading unit 67 along the guide-rail 71.

According to the mobile robot of the present invention, it is possible to detect without fail the environment around the mobile robot, and to move the mobile robot safely and promptly, using the detected information. Thus, the mobile robot can lightly and swiftly move a load without dropping it and appropriately follow the action of an object to be followed.

The present invention thus has advantages of detecting, without fail, the environment around the mobile robot, achieving the safe and swift movements of the mobile robot based on the detected information, and as such, the invention is useful in the field of mobile robot or the like.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

What is claimed is:

1. A mobile robot comprising:
a mobile robot body;
an external environment detection unit which is placed on said mobile robot so as to be movable, and is operable to detect an external environment; and
a control unit operable to control a posture of said external environment detection unit.

2. The mobile robot according to claim 1, further comprising:
an actuator which drives said external environment detection unit; and
at least one of a posture detection sensor which detects a posture of said mobile robot body, and an angle detection sensor which detects an angle between said mobile robot body and a surface on which said mobile robot body moves,
wherein said control unit is operable to receive, as an input, a detection value of one of said sensors, and to output a control signal for controlling a drive of said actuator.

3. The mobile robot according to claim 1,
wherein said control unit includes a linking unit operable to allow the posture of said external environment detection unit to be controlled according to a surface on which said mobile robot body moves, and to change the posture of said external environment detection unit so that the posture goes along the surface.

4. The mobile robot according to claim 1,
wherein said control unit includes a balancing member for keeping the posture of said external environment detection unit horizontal.

5. The mobile robot according to claim 1, further comprising:
two drive wheels which belong to a same rotation axis and are separately rotatable; and
a rotation control unit operable to control rotations of said drive wheels, and to control a position of said mobile robot body in an anteroposterior direction and a posture of said mobile robot body in a pitching direction.

6. The mobile robot according to claim 5,
wherein the rotation axis is located in a vertical line from a center of gravity of said mobile robot.

7. The mobile robot according to claim 5, further comprising:
a loading unit which is placed above said mobile robot body for loading an object to be carried; and
a posture detection sensor which detects an oscillation angle of said mobile robot body, and to output information about the detected angle to said rotation control unit,
wherein said rotation control unit is operable to control the oscillation angle of said mobile robot body so that said mobile robot does not tumble in a pitching direction, and
said external environment detection unit is placed above said loading unit.

8. The mobile robot according to claim 7,
wherein said loading unit is slidable in a horizontal direction.

9. The mobile robot according to claim 7, further comprising
a gantry frame placed above said mobile robot body so that said gantry frame protrudes upward,
wherein said external environment detection unit is placed on the top of said gantry frame.

10. The mobile robot according to claim 9,
wherein said gantry frame is bendable so that a space above said loading unit is enlarged.

11. The mobile robot according to claim 9,
wherein said gantry frame is extendable in a vertical direction.

12. The mobile robot according to claim 1,
wherein said external environment detection unit is an obstacle detection sensor.

13. A mobile robot comprising:
a mobile robot body;
drive wheels which are set on both sides of said mobile robot body;
a rotation control unit operable to control rotations of said drive wheels;
a support, placed on said mobile robot body, which supports a stage;
said stage supported by said support so as to be movable, independently from said mobile robot body, in a pitching direction;
an external environment detection unit placed on said stage; and
an actuator coupled to said support,
wherein said actuator controls a posture of said external environment detection unit by driving said stage so that said external environment detection unit is driven in the pitching direction.

14. A method for controlling a mobile robot, said method comprising:
detecting an angle between a mobile robot body and a surface on which the mobile robot body moves;
calculating, based on the detected angle, a value indicating an amount necessary for changing a present posture of an external environment detection unit; and
controlling drive of an actuator based on the calculated value so as to control the posture of the external environment detection unit.

15. The method for controlling a mobile robot, according to claim 14,
wherein the posture of the external environment detection unit is controlled so that the posture of the external environment detection unit is kept either horizontal or parallel to the surface.
